(19) United States
(12) Patent Application Publication
(10) Pub. No.: US 2026/0100626 A1
(43) Pub. Date: Apr. 9, 2026

(54) HAIRPIN COIL FORMING APPARATUS

(71) Applicants: Hyundai Motor Company, Seoul (KR); Kia Corporation, Seoul (KR); HYUNDAI WIA CORPORATION, Changwon-si (KR); HYUNDAI MOBIS CO., LTD., Seoul (KR)

(72) Inventors: Jeong Hyeon KIM, Hwaseong-si (KR); Sang Uk Jeon, Hwaseong-si (KR); Jae Ho Hwang, Hwaseong-si (KR); Chang Yeol Kim, Hwaseong-si (KR); Hyun Jun Lee, Hwaseong-Si (KR); Hyun Wook Nam, Suwon-si (KR); Cheol Bae Park, Changwon-si (KR)

(73) Assignees: Hyundai Motor Company, Seoul (KR); Kia Corporation, Seoul (KR); HYUNDAI WIA CORPORATION, Changwon-si (KR); HYUNDAI MOBIS CO., LTD., Seoul (KR)

(21) Appl. No.: 19/319,615

(22) Filed: Sep. 4, 2025

(30) Foreign Application Priority Data
Oct. 7, 2024 (KR) 10-2024-0135451

(51) Int. Cl. H02K 15/0421; B21F 3/02

(52) U.S. Cl. CPC H02K 15/0421; B21F 3/02

(57) ABSTRACT

A hairpin coil forming apparatus is adapted to form a straight coil material having a set length into a predetermined shape, and may include: i) a frame; ii) a shuttle plate disposed on the frame to be movable along a front-rear direction; iii) at least two or more coil forming molds disposed on the shuttle plate; iv) a mold driving source disposed on the frame to apply a drive force to one coil forming mold, which is positioned at a reference point of the frame, of the coil forming molds; and v) a material arrangement correction unit disposed on the frame to position the coil material loaded on the one coil forming mold at a set position in a set reference arrangement section.

### CROSS-REFERENCE TO RELATED APPLICATION

This application claims priority to and the benefit of Korean Patent Application No. 10-2024-0135451 filed with the Korean Intellectual Property Office on Oct. 7, 2024, the entire contents of which are incorporated herein by reference.

### BACKGROUND OF THE INVENTION

### Field of the Invention

An embodiment of the present disclosure relates to a hairpin coil forming apparatus, and more specifically, to a hairpin coil forming apparatus adapted to form a hairpin-type stator coil wound on a stator of a drive motor.

### Description of the Related Art

In general, hybrid vehicles or electric vehicles, which are called environmentally-friendly vehicles, apply technology of generating drive force by a drive motor.

As part of efforts to reduce the weight and volume of vehicles and parts, automakers and environment-friendly part manufacturers are developing drive motors with stators wound with hairpin-type stator coils (hereinafter, referred to as “hairpin coils”).

The hairpin coil is formed into a predetermined shape by a hairpin coil forming apparatus. The hairpin coil may be formed, in an example, into a U-shape, and in another example, into an I-shape.

A forming method of a typical hairpin coil forming apparatus for forming a U-shaped hairpin coil may include, for example, a method of bending a coil material using a bending tool and a method of pressing a coil material using a mold.

Of the two, a press-type hairpin coil forming apparatus using a mold may load a straight coil material of a set length onto a mold, perform a first forming process for forming the coil material into a V-shape using the mold, and perform a second forming process for forming the V-shaped coil material into a U-shape.

According to the press-type hairpin coil forming apparatus, when the straight coil material is loaded onto the mold through a loader, the straight coil material may not be positioned at a set position on the mold and may be loaded in a misaligned state.

Therefore, according to the press-type hairpin coil forming apparatus of the related art, a length deviation may occur in leg portions extending from a head portion of a U-shaped hairpin coil. The length deviation in the leg portions of the U-shaped hairpin coil may cause quality defects in subsequent processes (e.g., coil alignment process and widening process).

The matters described in the background art section are prepared to enhance understanding of the background of the invention, and may include matters that have not been known to one skilled in the art to which the present technology belongs.

### SUMMARY OF THE INVENTION

Embodiments of the present disclosure attempt to provide a hairpin coil forming apparatus configured to position a straight coil material at a set position in a set posture and to form the coil material into a U-shape.

A hairpin coil forming apparatus according to an embodiment of the present disclosure is configured to form a straight coil material having a set length into a predetermined shape and may include: i) a frame; ii) a shuttle plate disposed on the frame to be movable along a first direction; iii) at least two or more coil forming molds disposed on the shuttle plate; iv) a mold driving source disposed on the frame to apply a drive force to one coil forming mold, which is positioned at a reference point of the frame, of the coil forming molds; and v) a material arrangement correction unit disposed on the frame to position the coil material loaded on the one coil forming mold at a set position in a set reference arrangement section.

In addition, the hairpin coil forming apparatus according to an embodiment of the present disclosure may further include a coil discharge unit disposed at a reference point of the frame to discharge a hairpin coil formed by the one coil forming mold.

In addition, in the hairpin coil forming apparatus according to an embodiment of the present disclosure, the shuttle plate may be slidably coupled to at least one shuttle rail disposed on an upper surface of the frame along the first direction and may be connected to a shuttle driving unit disposed on the frame.

In addition, in the hairpin coil forming apparatus according to an embodiment of the present disclosure, each of the coil forming molds may include a mold holder fixed to the shuttle plate, a fixed die block fixed to the mold holder and having a U-shaped forming steel portion formed therein, an upper movable die block disposed on the mold holder to be movable in a second direction at a position corresponding to the fixed die block, and a lower movable die block disposed on the mold holder below the upper movable die block to be movable in the second direction.

In addition, in the hairpin coil forming apparatus according to an embodiment of the present disclosure, each of the coil forming molds may further include a pair of ball plungers disposed to the upper movable die block to form the straight coil material loaded onto the forming steel portion into a V-shape, and a pair of forming rollers disposed to the lower movable die block to form the pre-formed coil, which has been formed into a V-shape by the ball plungers, into a U-shape.

In addition, in the hairpin coil forming apparatus according to an embodiment of the present disclosure, each of the coil forming molds may further include at least one upper return spring disposed to the mold holder at a position corresponding to the upper movable die block, and at least one lower return spring disposed to the mold holder at a position corresponding to the lower movable die block.

In addition, in the hairpin coil forming apparatus according to an embodiment of the present disclosure, the forming rollers may be mounted to moving blocks coupled to the lower movable die block to be movable toward or away from each other along the first direction, respectively.

In addition, in the hairpin coil forming apparatus according to the exemplary embodiment of the present disclosure, the moving blocks may be connected to position adjustment driving units disposed on the mold holder.

In addition, in the hairpin coil forming apparatus according to an embodiment of the present disclosure, the forming rollers may be mounted to mounting blocks coupled to the moving blocks to be movable along the second direction.

In addition, in the hairpin coil forming apparatus according to an embodiment of the present disclosure, the mounting blocks may be fastened to position adjustment bolts rotatably coupled to the moving blocks.

In addition, in the hairpin coil forming apparatus according to an embodiment of the present disclosure, the mold driving source may include a mold actuator disposed on the frame, a push block connected to the mold actuator and disposed on the frame to be movable in the second direction by operation of the mold actuator, at least one upper push rod mounted to an upper portion of the push block to push the upper movable die block, and at least one lower push rod mounted to a lower portion of the push block to push the lower movable die block.

In addition, in the hairpin coil forming apparatus according to an embodiment of the present disclosure, the material arrangement correction unit may include a front correction module and a rear correction module disposed at front and rear portions of the frame, respectively, with the mold driving source interposed therebetween.

In addition, in the hairpin coil forming apparatus according to an embodiment of the present disclosure, the front correction module may include a front actuator disposed at the front portion of the frame, a front moving member connected to the front actuator and configured to move in the first direction by operation of the front actuator, a front bracket disposed on the front moving member and disposed along the second direction, a front locating block fixed to the front bracket, and a front guide block mounted to the front locating block.

In addition, in the hairpin coil forming apparatus according to an embodiment of the present disclosure, the front bracket may be connected to a front up-down cylinder disposed on the front moving member and may be configured to move in an upper-lower direction by operation of the front up-down cylinder.

In addition, in the hairpin coil forming apparatus according to an embodiment of the present disclosure, the rear correction module may include a rear actuator disposed at the rear portion of the frame, a rear moving member connected to the rear actuator and configured to move in the first direction by operation of the rear actuator, a rear bracket disposed on the rear moving member and disposed along the second direction, a rear locating block mounted to the rear bracket to be movable in the first direction, and a rear guide block mounted to the rear locating block.

In addition, in the hairpin coil forming apparatus according to the embodiment of the present invention, the rear bracket may be connected to a rear up-down cylinder disposed on the rear moving member and may be configured to move in the upper-lower direction by operation of the rear up-down cylinder.

In addition, in the hairpin coil forming apparatus according to an embodiment of the present disclosure, the front locating block may include a front edge locating portion configured to support an end portion on one side of the coil material, and a front stopping step portion stepped upward from the front edge locating portion.

In addition, in the hairpin coil forming apparatus according to an embodiment of the present disclosure, the rear locating block may include a rear edge locating portion configured to support an end portion on the other side of the coil material, and a rear stopping step portion stepped upward from the rear edge locating portion.

In addition, in the hairpin coil forming apparatus according to an embodiment of the present disclosure, the front guide block may an include a front guide inclined surface formed to guide the end portion on one side of the coil material to the front stopping step portion.

In addition, in the hairpin coil forming apparatus according to an embodiment of the present disclosure, the rear guide block may an include a rear guide inclined surface formed to guide the end portion on the other side of the coil material to the rear stopping step portion.

In addition, in the hairpin coil forming apparatus according to an embodiment of the present disclosure, the rear locating block may be mounted to the rear bracket to be movable in the first direction through at least one guide rod fixed to the rear bracket.

In addition, in the hairpin coil forming apparatus according to an embodiment of the present disclosure, a rear spring may be mounted to the at least one guide rod.

In addition, in the hairpin coil forming apparatus according to an embodiment of the present disclosure, the coil discharge unit may include a swing block connected to a turning cylinder disposed on the frame and configured to perform swing rotation in the upper-lower direction by operation of the turning cylinder, a pair of lower clamp pads connected to an up-down clamp cylinder disposed on the swing block and configured to move in the upper-lower direction, respectively, by operation of the up-down clamp cylinder, and a pair of upper clamp pads mounted to the swing block and disposed above the pair of lower clamp pads.

In addition, in the hairpin coil forming apparatus according to an embodiment of the present disclosure, the upper clamp pads may be connected to a horizontal clamp cylinder disposed on the swing block and may be configured to move toward or away from each other along the first direction by operation of the horizontal clamp cylinder.

According to the hairpin coil forming apparatus according to embodiments of the present disclosure, the forming quality of the hairpin coil can be secured by minimizing the quality variation of the hairpin coil.

In addition, the effects that can be obtained or expected by the embodiments of the present disclosure will be directly or implicitly disclosed in the detailed description of the embodiments of the present disclosure. That is, various effects that may be expected by the embodiments of the present disclosure will be disclosed in the detailed description described below.

### BRIEF DESCRIPTION OF THE DRAWINGS

Since the accompanying drawings are for reference in describing embodiments of the present disclosure, the technical spirit of the present disclosure should not be construed as being limited to the accompanying drawings.

FIG. 1 is a perspective view illustrating a hairpin coil forming apparatus according to an embodiment of the present disclosure.

FIG. 2 is a plan view illustrating the hairpin coil forming apparatus according to an embodiment of the present disclosure.

FIG. 3 is a view illustrating a forming process of a U-shaped hairpin coil formed by the hairpin coil forming apparatus according to an embodiment of the present disclosure.

FIG. 4 and FIG. 5 are views illustrating portions of a shuttle plate applied to the hairpin coil forming apparatus according to an embodiment of the present disclosure.

FIG. 6 and FIG. 7 are views illustrating an arrangement structure of coil forming molds applied to the hairpin coil forming apparatus according to an embodiment of the present disclosure.

FIG. 8 is a perspective view illustrating a coil forming mold applied to the hairpin coil forming apparatus according to an embodiment of the present disclosure.

FIG. 9 is a plan view illustrating the coil forming mold applied to the hairpin coil forming apparatus according to an embodiment of the present disclosure.

FIG. 10 is a plan view illustrating a portion of a fixed die block of the coil forming mold applied to the hairpin coil forming apparatus according to an embodiment of the present disclosure.

FIG. 11 is a plan view illustrating a portion of ball plungers of the coil forming mold applied to the hairpin coil forming apparatus according to an embodiment of the present disclosure.

FIG. 12 is a perspective view illustrating a ball plunger of the coil forming mold applied to the hairpin coil forming apparatus according to an embodiment of the present disclosure.

FIG. 13 is a plan view illustrating a portion of forming rollers of the coil forming mold applied to the hairpin coil forming apparatus according to an embodiment of the present disclosure.

FIG. 14 and FIG. 15 are views illustrating a mounting structure of the forming rollers of the coil forming mold applied to the hairpin coil forming apparatus according to an embodiment of the present disclosure.

FIG. 16 is a perspective view illustrating a mold driving source applied to the hairpin coil forming apparatus according to an embodiment of the present disclosure.

FIG. 17 is a front view illustrating the mold driving source applied to the hairpin coil forming apparatus according to an embodiment of the present disclosure.

FIG. 18 is a plan view illustrating the mold driving source applied to the hairpin coil forming apparatus according to an embodiment of the present disclosure.

FIG. 19 is a block diagram schematically illustrating a return spring mounting structure of the coil forming mold applied to the hairpin coil forming apparatus according to an embodiment of the present disclosure.

FIG. 20 is a plan view illustrating a material arrangement correction unit applied to the hairpin coil forming apparatus according to an embodiment of the present disclosure.

FIG. 21 is a perspective view illustrating the material arrangement correction unit applied to the hairpin coil forming apparatus according to an embodiment of the present disclosure.

FIG. 22 is a plan view illustrating a front correction module of the material arrangement correction unit applied to the hairpin coil forming apparatus according to an embodiment of the present disclosure.

FIG. 23 is a plan view illustrating a rear correction module of the material arrangement correction unit applied to the hairpin coil forming apparatus according to an embodiment of the present disclosure.

FIG. 24 is a plan view illustrating a coil discharge unit applied to the hairpin coil forming apparatus according to an embodiment of the present disclosure.

FIG. 25 is a perspective view illustrating the coil discharge unit applied to the hairpin coil forming apparatus according to an embodiment of the present disclosure.

FIG. 26 is a side view illustrating the coil discharge unit applied to the hairpin coil forming apparatus according to an embodiment of the present disclosure.

It should be understood that the above-referenced drawings are not necessarily drawn to scale, and present rather simplified representations of various preferred features illustrating the basic principles of the present disclosure. For example, the specific design features of the present disclosure, including, for example, specific dimensions, orientations, locations, and shapes, will be determined in part by the specific intended application and use environment.

### DETAILED DESCRIPTION OF THE EMBODIMENTS

The present disclosure will be described more fully hereinafter with reference to the accompanying drawings, in which embodiments of the invention are shown. As those skilled in the art would realize, the described embodiments may be modified in various different ways, all without departing from the spirit or scope of the present disclosure.

The drawings and description are to be regarded as illustrative in nature and not restrictive. Like reference numerals designate like elements throughout the specification.

In addition, the size and thickness of each component shown in the drawings are arbitrarily shown for convenience of explanation, so the present disclosure is not necessarily limited to what is shown in the drawings, and the thickness is exaggerated to clearly express various portions and areas.

The terminology used herein is intended to describe particular embodiments and is not intended to limit the invention. As used herein, the singular forms are intended to include the plural forms as well, unless the context clearly indicates otherwise.

It will be further understood that the terms “comprise (include)” and/or “comprising (including)” when used in this specification specify the presence of stated features, integers, steps, operations, elements and/or components, but do not preclude the presence or addition of one or more other features, integers, steps, operations, components, and/or groups thereof.

As used herein, the term ‘coupled’ denotes a physical relationship between two components, in which the components are connected to each other directly or indirectly via one or more intermediary components.

In addition, as used herein, the term “operably connected” or similar terms means that at least two members are directly or indirectly connected to each other and can transmit power. However, two operably connected members do not always rotate at the same speed and in the same direction.

Furthermore, as used herein, the terms ‘vehicle’, ‘vehicular’, ‘automobile’ or other similar terms as used herein generally refer to passenger automobiles including passenger vehicles, sports utility vehicles (SUVs), buses, trucks, and various commercial vehicles, which may include hybrid automobiles equipped with high voltage batteries, electric automobiles, hybrid electric automobiles, electric vehicle-based Purpose built vehicles (PBVs), and hydrogen-powered vehicles (also commonly referred to by those skilled in the art as ‘hydrogen electric vehicles’).

Hereinafter, embodiments of the present disclosure will be described in detail with reference to the accompanying drawings.

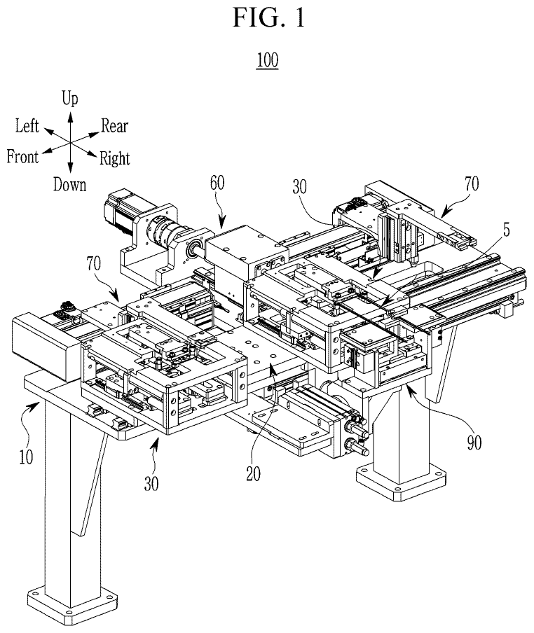

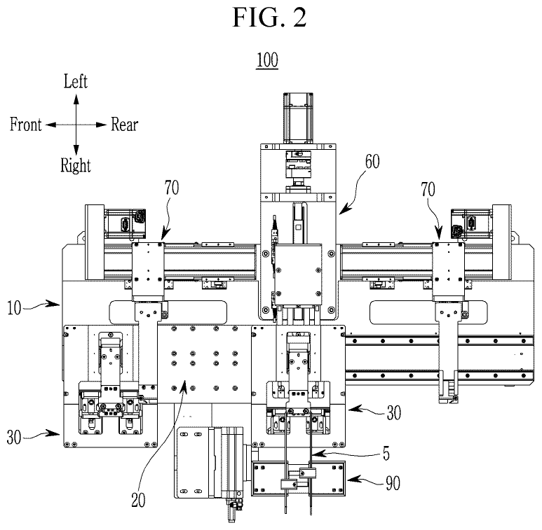

FIG. 1 is a perspective view illustrating a hairpin coil forming apparatus according to an embodiment of the present disclosure, and FIG. 2 is a plan view illustrating the hairpin coil forming apparatus according to an embodiment of the present disclosure.

Referring to FIGS. 1 and 2, a hairpin coil forming apparatus 100 according to an embodiment of the present disclosure may be applied to a process for forming hairpin-type stator coils wound on a stator core into a predetermined shape among processes for manufacturing a stator of a drive motor.

The hairpin winding-type stator may be applied to a drive motor for an environmentally friendly vehicle that obtains drive force from electric energy, such as a hybrid vehicle and/or an electric vehicle. Here, the hairpin-type stator coils may also be referred to as conductor coils, segment coils or flat coils.

In an example, the stator coils may include U-shaped stator coils formed into a U-shaped hairpin type and I-shaped stator coils formed into an I-shaped hairpin type.

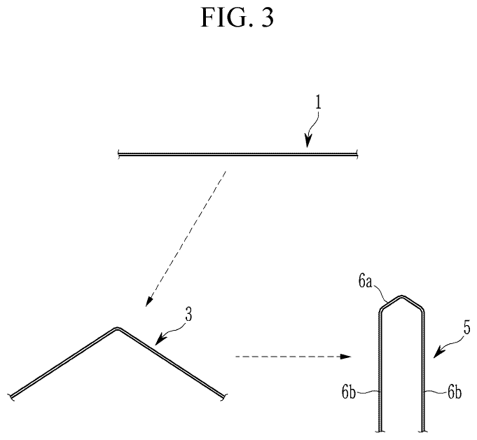

Among these, the U-shaped stator coils may be manufactured through a process of 2D forming a straight coil material 1 into a U-shaped hairpin coil 5 by the hairpin coil forming apparatus 100 according to an embodiment of the present disclosure, as illustrated in FIG. 3, and a process of 3D forming a head portion 6a of the hairpin coil 5 by a separate coil forming apparatus.

Here, the coil material 1 may be provided to the 2D forming process of the hairpin coil 5 in a state where it has been flattened into a straight line shape and cut to a length set according to the specifications of the stator in a previous process of the 2D forming process of the hairpin coil 5.

In the present specification, the reference direction for describing the following components may be set as the front-rear direction, left-right direction, and upper-lower direction based on the drawing.

Furthermore, in the present specification, an ‘upper end portion’, ‘upper portion’, ‘upper end’ or ‘upper surface’ of a component refers to an end portion, portion, end, or surface of the component located on a relatively upper side in the drawing, and a ‘lower end portion’, ‘lower portion’, ‘lower end’ or ‘lower surface’ of a component refers to an end portion, portion, end, or surface of the component located on a relatively lower side in the drawing.

Furthermore, in the present specification, an end of a component (e.g., an end on one side or an end on another (other) side, etc.) refers to an end of the component in any one direction, and an end portion of a component (e.g., an end portion on one side or an end portion on another (other) side, etc.) refers to a certain portion of the component including the end.

Note that the hairpin coil forming apparatus 100 according to an embodiment of the present disclosure is configured to primarily form the straight coil material 1 as shown in FIG. 3 into a V-shape, and secondarily form the pre-formed coil 3, which has been primarily formed, into a U-shape, thereby manufacturing the hairpin coil 5 as described above.

Here, the primary forming process of the coil material 1 and the secondary forming process of the pre-formed coil 3 may be performed continuously by the hairpin coil forming apparatus 100 according to an embodiment of the present disclosure.

In FIG. 3, a reference numeral 6b, which is not described, indicates leg portions of the hairpin coil 5.

The hairpin coil forming apparatus 100 according to an embodiment of the present disclosure provides a structure configured for positioning the straight coil material 1 at a set position in a set posture and 2D forming the coil material 1 into the U-shaped hairpin coil 5.

To this end, the hairpin coil forming apparatus 100 according to an embodiment of the present disclosure includes a frame 10, a shuttle plate 20, at least two or more coil forming molds 30, a mold driving source 60, a material arrangement correction unit 70, and a coil discharge unit 90.

The coil material 1, the pre-formed coil 3, the finally 2D-formed hairpin coil 5, and the head portion 6a and leg portions 6b of the hairpin coil 5 described below will refer to FIG. 3.

In an embodiment of the present disclosure, the frame 10 is adapted to mount various components described below. The frame 10 is fixed to the floor of the process workspace and may be composed of a single frame or a frame divided into two or more sections.

Such a frame 10 may include various auxiliary elements, such as brackets, plates, blocks, rods, and partitions configured to support various components.

However, since the various auxiliary elements described above are intended to mount the respective components described below to the frame 10, in the exemplary embodiment of the present disclosure, the various auxiliary elements described above are collectively referred to as the frame 10, except for exceptional cases.

In an embodiment of the present disclosure, the shuttle plate 20 is disposed on the frame 10 to be movable along the front-rear direction.

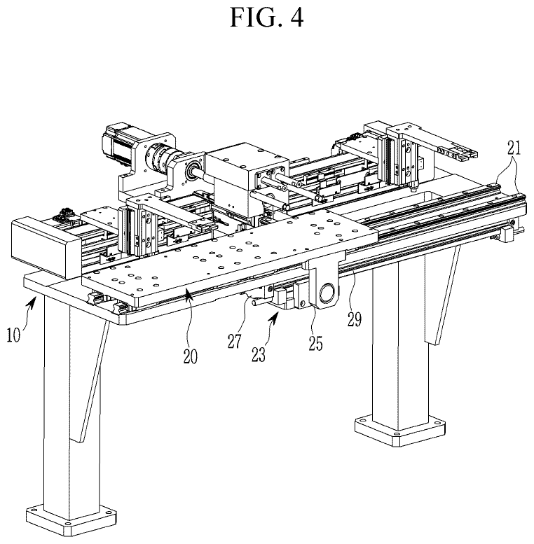

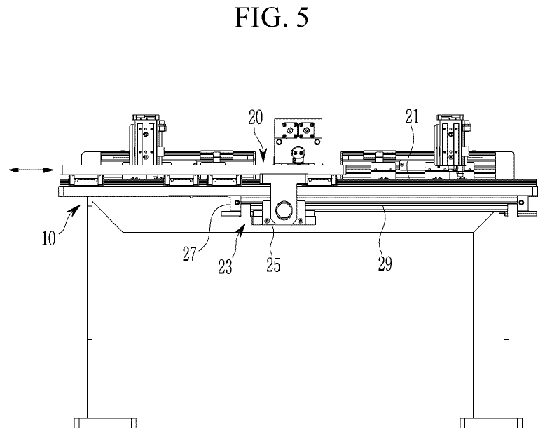

FIGS. 4 and 5 are views illustrating portions of a shuttle plate applied to the hairpin coil forming apparatus according to an embodiment of the present disclosure.

Referring to FIGS. 4 and 5, the shuttle plate 20 according to an embodiment of the present disclosure is disposed along the front-rear direction on the frame 10. The shuttle plate 20 is slidably coupled to a pair of shuttle rails 21 mounted along the front-rear direction on an upper surface of the frame 10.

The shuttle plate 20 is operably connected to a shuttle driving unit 23 disposed on the frame 10. The shuttle plate 20 is connected to the shuttle driving unit 23 through a shuttle connection block 25. The shuttle plate 20 can be moved in the front-rear direction along the shuttle rails 21 through the shuttle connection block 25 by operation of the shuttle driving unit 23.

In an example, the shuttle driving unit 23 may include a first servo motor 27.

The first servo motor 27 may be a motor configured for servo control of rotation speed and rotation direction.

The shuttle connection block 25 is screw-coupled to a typical lead screw connected to the first servo motor 27 and can be slidably coupled to a first guide mechanism 29 mounted along the front-rear direction on the frame 10.

That is, the shuttle plate 20 can be moved in the front-rear direction along the shuttle rails 21 through the shuttle connection block 25 that moves in the front-rear direction along the first guide mechanism 29 by rotation of the lead screw.

Referring to FIGS. 1 and 2, in an embodiment of the present disclosure, the at least two or more coil forming molds 30 are configured to form the straight coil material 1 into the U-shaped hairpin coil 5.

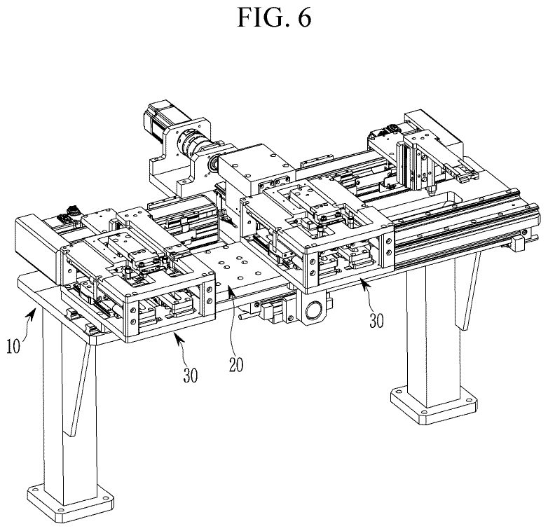

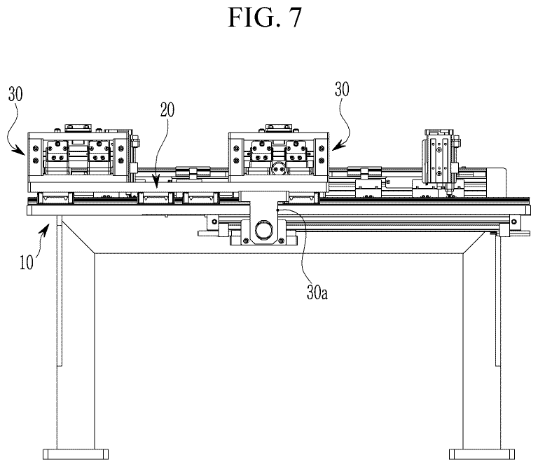

FIGS. 6 and 7 are views illustrating an arrangement structure of coil forming molds applied to the hairpin coil forming apparatus according to an embodiment of the present disclosure.

Referring to FIGS. 6 and 7, the coil forming molds 30 according to an embodiment of the present disclosure are disposed on the shuttle plate 20. The coil forming molds 30 are disposed spaced apart from each other at set intervals along the front-rear direction on the shuttle plate 20.

The coil forming molds 30 may be provided as dedicated molds for forming hairpin coils 5 of different shapes according to the specifications of the stator coils wound on the stator.

Here, one of the coil forming molds 30 is positioned at a reference point 30a set on the frame 10 by the shuttle plate 20 moving in the front-rear direction, and can 2D form the straight coil material 1 into a U-shape.

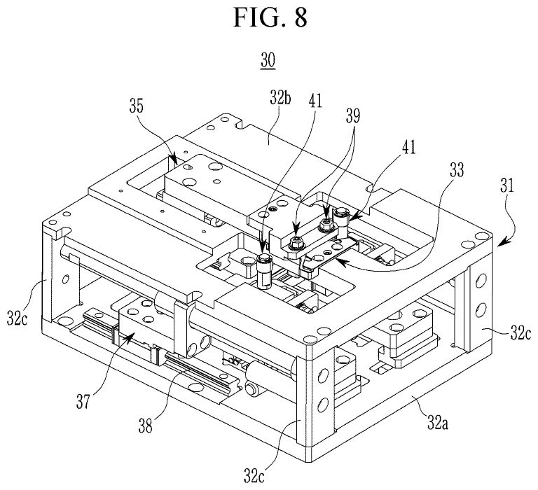

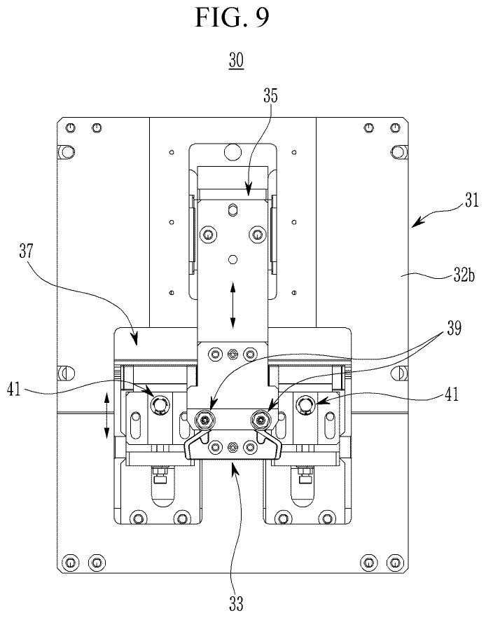

FIG. 8 is a perspective view illustrating a coil forming mold applied to the hairpin coil forming apparatus according to an embodiment of the present disclosure, and FIG. 9 is a plan view illustrating the coil forming mold applied to the hairpin coil forming apparatus according to an embodiment of the present disclosure.

Referring to FIGS. 6 to 9, each of the coil forming molds 30 according to an embodiment of the present disclosure includes a mold holder 31, a fixed die block 33, an upper movable die block 35, a lower movable die block 37, a pair of ball plungers 39, and a pair of forming rollers 41.

The mold holder 31 is fixed to the shuttle plate 20. The mold holder 31 includes, in an example, a base block 32a, an upper block 32b, and a plurality of support blocks 32c.

Here, the support blocks 32c are disposed between the base block 32a and the upper block 32b, and are connected to corners of the base block 32a and the upper block 32b along the upper-lower direction.

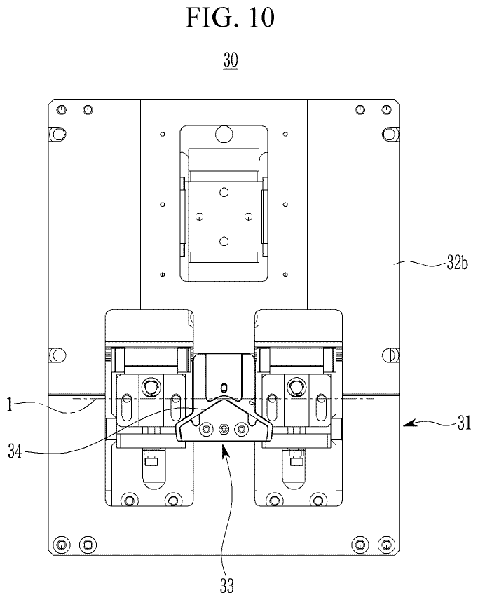

The fixed die block 33 is fixed to the upper block 32b of the mold holder 31. The fixed die block 33 includes a forming steel portion 34 formed in a U-shape, as shown in FIG. 10.

The forming steel portion 34 is formed in an inverted U-shape based on the drawing. The forming steel portion 34 supports the straight coil material 1 and can guide V-shape forming and U-shape forming of the coil material 1.

Referring to FIGS. 8 and 9, the upper movable die block 35 is disposed on the mold holder 31 at a position corresponding to the fixed die block 33 to be movable along the left-right direction.

The upper movable die block 35 can be moved in the left-right direction by a set stroke along guide rails provided on an upper portion of the mold holder 31.

Referring to FIGS. 8 and 9, the lower movable die block 37 is disposed on the mold holder 31 below the upper movable die block 35 to be movable in the left-right direction.

The lower movable die block 37 can be moved in the left-right direction by a set stroke along guide rails 38 provided on the lower portion of the mold holder 31.

Here, the upper movable die block 35 and the lower movable die block 37 described above can be moved forward and rearward along the left-right direction with a set time difference.

For example, the upper movable die block 35 may move forward first, and then the lower movable die block 37 may move forward. The lower movable die block 37 may move rearward first, and then the upper movable die block 35 may move rearward.

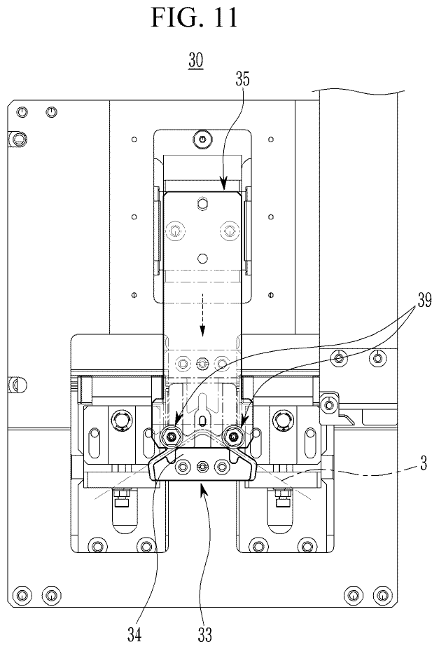

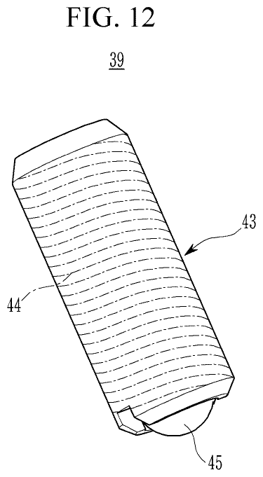

FIG. 11 is a plan view illustrating a portion of ball plungers of the coil forming mold applied to the hairpin coil forming apparatus according to an embodiment of the present disclosure, and FIG. 12 is a perspective view illustrating a ball plunger of the coil forming mold applied to the hairpin coil forming apparatus according to an embodiment of the present disclosure.

Referring to FIGS. 10 to 12, the ball plungers 39 are configured to bend and form the straight coil material 1 loaded onto the forming steel portion 34 of the fixed die block 33 into a V-shaped pre-formed coil 3.

The ball plungers 39 are mounted to the upper movable die block 35 at positions corresponding to the forming steel portion 34. Each of the ball plungers 39 includes a plunger body 43 and a ball 45 (see FIG. 12).

The plunger body 43 is provided as a cylindrical body and may be fastened to the upper movable die block 35 along the upper-lower direction. Accordingly, an external peripheral surface of the plunger body 43 is formed with screw threads 44 that can be fastened with the upper movable die block 35.

The ball 45 is rolling-rotatably mounted to a lower end of the plunger body 43. The ball 45 comes into rolling contact with the straight coil material 1 along the forming steel portion 34 by the forward movement of the upper movable die block 35, and can bend and form the coil material 1 into a V-shape.

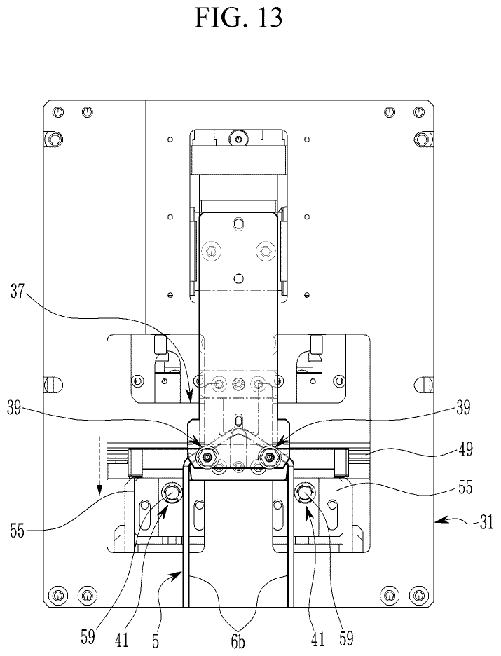

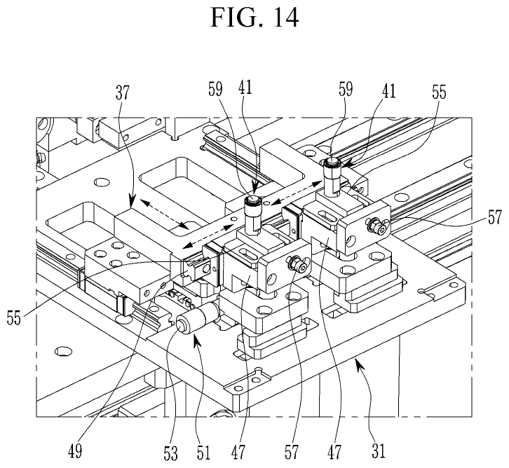

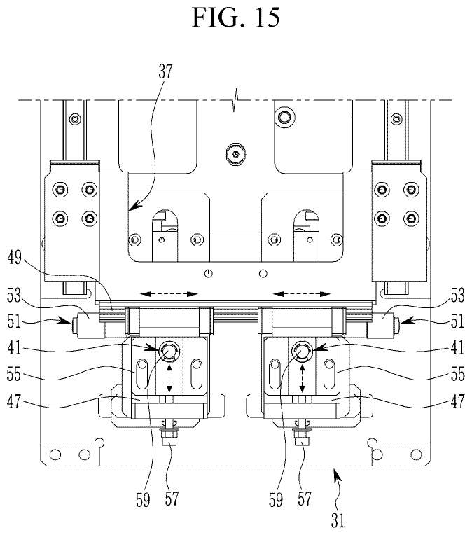

FIG. 13 is a plan view illustrating a portion of forming rollers of the coil forming mold applied to the hairpin coil forming apparatus according to an embodiment of the present disclosure, and FIGS. 14 and 15 are views illustrating a mounting structure of the forming rollers of the coil forming mold applied to the hairpin coil forming apparatus according to an embodiment of the present disclosure.

Referring to FIGS. 13 to 15, the forming rollers 41 are configured to form the pre-formed coil 3 (see FIG. 11), which has been formed into a V-shape by the ball plungers 39, into a U-shaped hairpin coil 5 by the forming steel portion 34 of the fixed die block 33.

The forming rollers 41 are mounted to the lower movable die block 37. The forming rollers 41 are mounted to moving blocks 47, respectively, which are coupled to the lower movable die block 37 to be movable toward or away from each other along the front-rear direction.

That is, the positions of the forming rollers 41 in the front-rear direction can be adjusted in a direction toward or away from each other by movement of the moving blocks 47, based on the spacing between the leg portions 6b of the hairpin coil 5.

The moving blocks 47 may be coupled to a rail block 49 provided on the lower movable die block 37 to be slidable along the front-rear direction.

Furthermore, the moving blocks 47 are operably connected to position adjustment driving units 51 disposed on the mold holder 31. The moving blocks 47 may be moved away from or toward each other along the rail block 49 by operation of the position adjustment driving units 51.

In an example, each of the position adjustment driving units 51 may include a second servo motor 53. The second servo motor 53 may be a motor configured for servo control of rotation speed and rotation direction.

The moving blocks 47 are screw-coupled to a typical lead screw connected to the second servo motor 53 and can be slidably coupled to a guide mechanism mounted along the front-rear direction on the mold holder 31.

That is, the moving blocks 47 can be moved away from or toward each other along the front-rear direction through the guide mechanism and the rail block 49 by rotation of the lead screw.

The forming rollers 41 as described above may be mounted to mounting blocks 55 coupled to the moving blocks 47 to be movable along the left-right direction.

The mounting blocks 55 are coupled to the upper portions of the movable blocks 47 to be slidable along the left-right direction, and can be fastened with position adjustment bolts 57 rotatably coupled to the movable blocks 47.

Here, the positions of the forming rollers 41 in the left-right direction can be adjusted by movement of the mounting blocks 55 caused by the rotation of the position adjustment bolts 57, based on the predetermined shape of the head portion 6a of the hairpin coil 5.

Furthermore, the forming rollers 41 are rotatably disposed on roller shafts 59 mounted to the mounting blocks 55 along the upper-lower direction. The forming rollers 41 come into rolling contact with the pre-formed coil 3 by the forward movement of the lower movable die block 37 and can bend and form the pre-formed coil 3 into a U-shape through the forming steel portion 34.

Referring to FIGS. 1 and 2, in an embodiment of the present disclosure, the mold driving source 60 is configured to apply drive force to one coil forming mold 30 positioned at the reference point 30a (see FIG. 7) of the frame 10 among the coil forming molds 30. The mold driving source 60 is disposed on the frame 10 along the left-right direction.

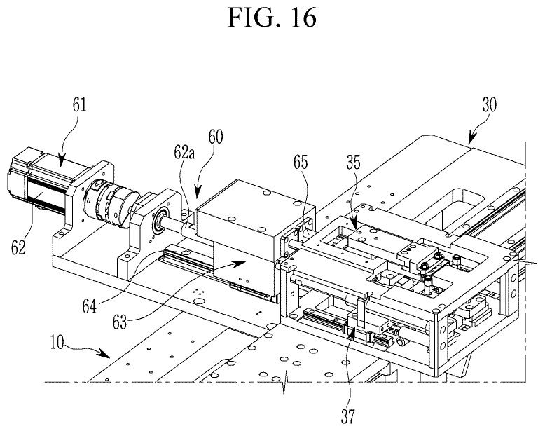

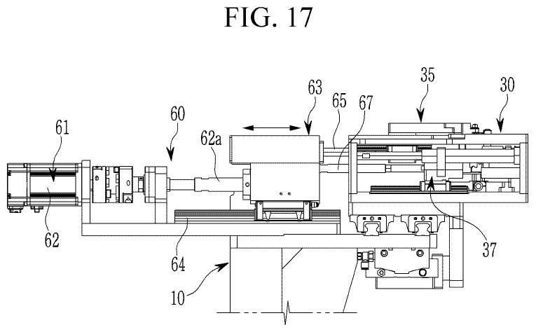

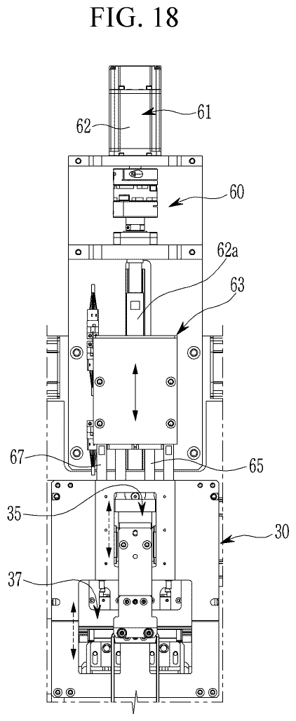

FIG. 16 is a perspective view illustrating a mold driving source applied to the hairpin coil forming apparatus according to an embodiment of the present disclosure, FIG. 17 is a front view illustrating the mold driving source applied to the hairpin coil forming apparatus according to an embodiment of the present disclosure, and FIG. 18 is a plan view illustrating the mold driving source applied to the hairpin coil forming apparatus according to an embodiment of the present disclosure.

Referring to FIGS. 16 to 18, the mold driving source 60 according to an embodiment of the present disclosure includes a mold actuator 61, a push block 63, at least one upper push rod 65, and at least one lower push rod 67.

The mold actuator 61 is disposed on the frame 10. In an example, the mold actuator 61 may include a third servo motor 62. The third servo motor 62 may be a motor configured for servo control of rotation speed and rotation direction.

The push block 63 is operably connected to the third servo motor 62 of the mold actuator 61. The push block 63 is disposed on the frame 10 to be movable in the left-right direction by operation of the third servo motor 62.

Here, the push block 63 is slidably coupled to a rail member 64 mounted along the left-right direction on the frame 10. The push block 63 is screw-coupled to a lead screw 62a connected to the third servo motor 62. Accordingly, the push block 63 can be moved along the left-right direction through the rail member 64 by rotation of the lead screw 62a.

The at least one upper push rod 65 is configured to push the upper movable die block 35 of the coil forming mold 30 located at the reference point 30a (see FIG. 7) of the frame 10 along the left-right direction by the push block 63.

The at least one upper push rod 65 is mounted to an upper portion of the push block 63 and is disposed along the left-right direction.

The at least one lower push rod 67 is configured to push the lower movable die block 37 of the coil forming mold 30 along the left-right direction by the push block 63.

The at least one lower push rod 67 is mounted to a lower portion of the push block 63 and is disposed along the left-right direction.

Here, the at least one upper push rod 65 and the at least one lower push rod 67 have different lengths and can push the upper movable die block 35 and the lower movable die block 37, respectively.

For example, the at least one upper push rod 65 may be provided to have a length longer than that of the at least one lower push rod 67.

Accordingly, the upper movable die block 35 can move forward first, and then the lower movable die block 37 can move forward, and the lower movable die block 37 can move rearward first, and then the upper movable die block 35 can move rearward.

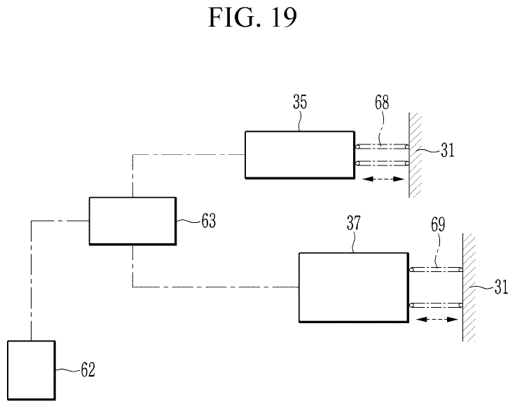

Note that, each of the coil forming molds 30 according to an embodiment of the present disclosure further includes at least one upper return spring 68 and at least one lower return spring 69, as shown in FIG. 19.

The at least one upper return spring 68 is mounted to the mold holder 31 at a position corresponding to the upper movable die block 35.

The at least one upper return spring 68 can be compressed by the forward movement of the upper movable die block 35 when the push block 63 moves forward by the operation of the third servo motor 62.

The at least one upper return spring 68 can move the upper movable die block 35 rearward by elastic restoring force when the push block 63 moves rearward by the operation of the third servo motor 62.

The at least one lower return spring 69 is mounted to the mold holder 31 at a position corresponding to the lower movable die block 37.

The at least one lower return spring 69 can be compressed by the forward movement of the lower movable die block 37 when the push block 63 moves forward by the operation of the third servo motor 62.

The at least one lower return spring 69 can move the lower movable die block 37 rearward by elastic restoring force when the push block 63 moves rearward by the operation of the third servo motor 62.

Referring to FIGS. 1 and 2, in an embodiment of the present disclosure, the material arrangement correction unit 70 is configured to correct arrangement of the straight coil material 1 loaded onto the coil forming mold 30 positioned at the reference point 30a of the frame 10 (see FIG. 7). The material arrangement correction unit 70 is disposed on the frame 10.

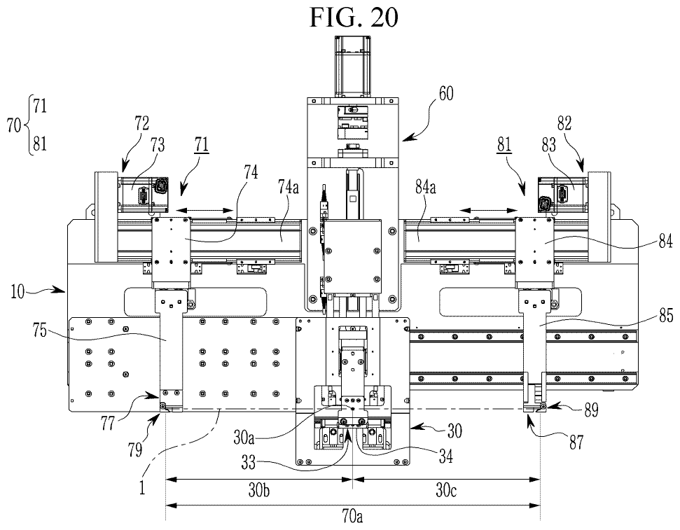

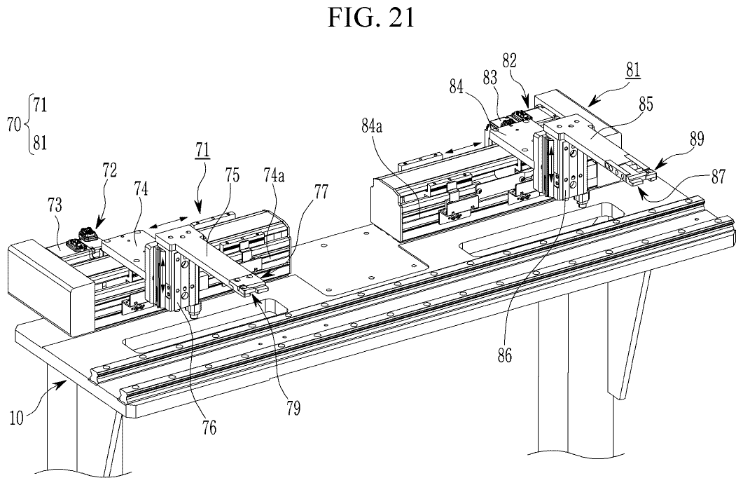

FIG. 20 is a plan view illustrating a material arrangement correction unit applied to the hairpin coil forming apparatus according to an embodiment of the present disclosure, and FIG. 21 is a perspective view illustrating the material arrangement correction unit applied to the hairpin coil forming apparatus according to an embodiment of the present disclosure.

Referring to FIGS. 20 and 21, the material arrangement correction unit 70 according to an embodiment of the present disclosure is configured to position the straight coil material 1 loaded onto the coil forming mold 30 in a set reference arrangement section 70a.

The reference arrangement section 70a here may be defined as a section corresponding to a length of the straight coil material 1 loaded onto the forming steel portion 34 of the fixed die block 33 of the coil forming mold 30.

In the reference arrangement section 70a, a length of a front section 30b and a length of a rear section 30c divided based on the reference point 30a of the frame 10 may differ depending on the specifications of the hairpin coil 5.

In addition, the set position of the straight coil material 1 here may be defined as a set posture in which the coil material 1 disposed in the reference arrangement section 70a is not misaligned in the left-right direction and maintains a horizontal orientation along the front-rear direction in the reference arrangement section 70a.

The material arrangement correction unit 70 includes a front correction module 71 and a rear correction module 81, which are respectively disposed at front and rear portions of the frame 10 with the mold driving source 60 interposed therebetween.

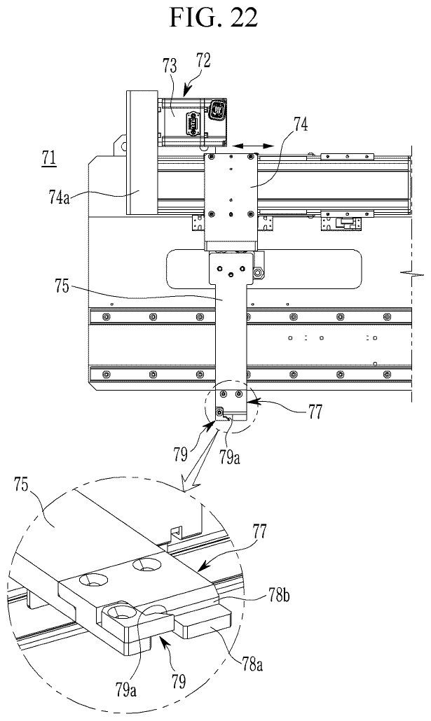

FIG. 22 is a plan view illustrating a front correction module of the material arrangement correction unit applied to the hairpin coil forming apparatus according to an embodiment of the present disclosure.

Referring to FIGS. 20 to 22, the front correction module 71 according to an embodiment of the present disclosure includes a front actuator 72, a front moving member 74, a front bracket 75, a front locating block 77, and a front guide block 79.

The front actuator 72 is disposed at the front portion of the frame 10. In an example, the front actuator 72 may include a fourth servo motor 73. The fourth servo motor 73 may be a motor configured for servo control of rotation speed and rotation direction.

The front moving member 74 is operably connected to the fourth servo motor 73 and can be moved in the front-rear direction by operation of the fourth servo motor 73.

Here, the front moving member 74 is screw-coupled to a typical lead screw connected to the fourth servo motor 73 and can be slidably coupled to a second guide mechanism 74a mounted along the front-rear direction on the frame 10.

The front bracket 75 is disposed on the front moving member 74 and is disposed along the left and right directions.

The front bracket 75 is operably connected to a front up-down cylinder 76 disposed on the front moving member 74. The front bracket 75 can be moved in the upper-lower direction by operation of the front up-down cylinder 76. The front up-down cylinder 76 may, in an example, include a pneumatic cylinder.

The front locating block 77 is fixed to the front bracket 75. The front locating block 77 includes a front edge locating portion 78a and a front stopping step portion 78b.

The front edge locating portion 78a is configured to support an end portion on one side of the coil material 1 along the upper-lower direction. In an example, the front edge locating portion 78a is formed in a projection shape on the front locating block 77.

The front stopping step portion 78b is configured to support an end portion on one side of the coil material 1 along the left-right direction. The front stopping step portion 78b extends upward in a stepped manner from the front edge locating portion 78a.

The front guide block 79 is mounted on the front locating block 77. The front guide block 79 is formed with a front guide inclined surface 79a that guides an end portion on one side of the coil material 1 to the front stopping step portion 78b.

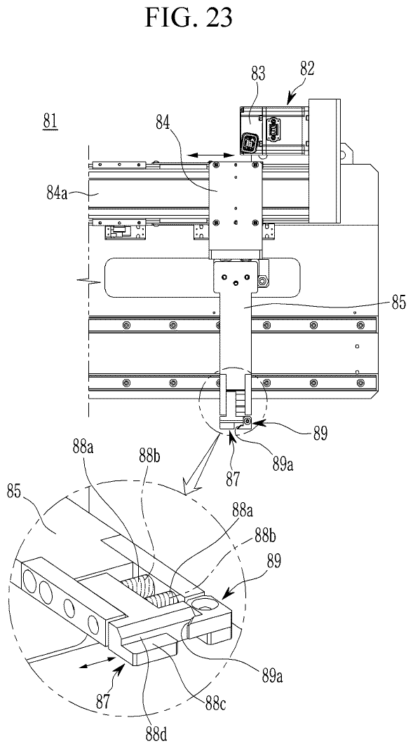

FIG. 23 is a plan view illustrating a rear correction module of the material arrangement correction unit applied to the hairpin coil forming apparatus according to an embodiment of the present disclosure.

Referring to FIGS. 20, 21 and 23, the rear correction module 81 according to an embodiment of the present disclosure includes a rear actuator 82, a rear moving member 84, a rear bracket 85, a rear locating block 87, and a rear guide block 89.

The rear actuator 82 is disposed at the rear portion of the frame 10. In an example, the rear actuator 82 may include a fifth servo motor 83. The fifth servo motor 83 may be a motor configured for servo control of rotation speed and rotation direction.

The rear moving member 84 is operably connected to the fifth servo motor 83 and can be moved in the front-rear direction by operation of the fifth servo motor 83.

Here, the rear moving member 84 is screw-coupled to a typical lead screw connected to the fifth servo motor 83 and can be slidably coupled to a third guide mechanism 84a mounted along the front-rear direction on the frame 10.

The rear bracket 85 is disposed on the rear moving member 84 and is disposed along the left-right direction.

The rear bracket 85 is operably connected to a rear up-down cylinder 86 disposed on the rear moving member 84. The rear bracket 85 can be moved in the upper-lower direction by operation of the rear up-down cylinder 86. The rear up-down cylinder 86 may, in an example, include a pneumatic cylinder.

The rear locating block 87 is mounted to the rear bracket 85 to be movable in the front-rear direction.

The rear locating block 87 is mounted to the rear bracket 85 to be movable in the front-rear direction through a pair of guide rods 88a fixed to the rear bracket 85. The guide rods 88a are fixed to the rear bracket 85, and the rear locating block 87 is coupled to the guide rods 88a to be movable in the front-rear direction. Rear springs 88b are mounted to the guide rods 88a.

Furthermore, the rear locating block 87 includes a rear edge locating portion 88c and a rear stopping step portion 88d.

The rear edge locating portion 88c is configured to support an end portion on the other side of the coil material 1 along the upper-lower direction. In an example, the rear edge locating portion 88c is formed in a projection shape on the rear locating block 87.

The rear stopping step portion 88d is configured to support an end portion on the other side of the coil material 1 along the left-right direction. The rear stopping step portion 88d extends upward in a stepped manner from the rear edge locating portion 88c.

The rear guide block 89 is mounted on the rear locating block 87. The rear guide block 89 is formed with a rear guide inclined surface 89a that guides an end portion on the other side of the coil material 1 to the rear stopping step portion 88d.

Referring to FIGS. 1 and 2, in an embodiment of the present disclosure, the coil discharge unit 90 is configured to discharge the hairpin coil 5 that has been formed by the coil forming mold 30 positioned at the reference point 30a (see FIG. 7) of the frame 10.

The coil discharge unit 90 is disposed at a position corresponding to the coil forming mold 30 and is disposed at the reference point 30a of the frame 10 (see FIG. 7).

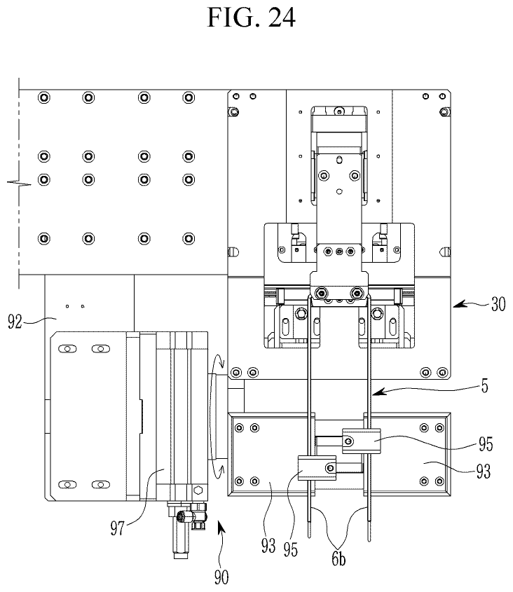

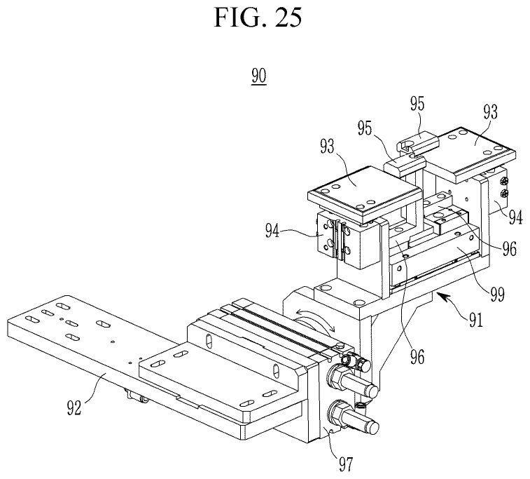

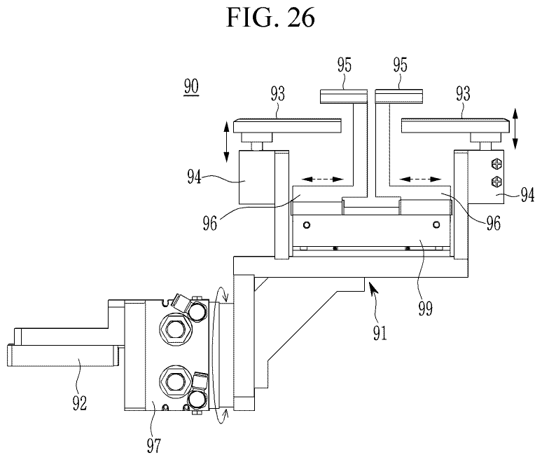

FIG. 24 is a plan view illustrating a coil discharge unit applied to the hairpin coil forming apparatus according to an embodiment of the present disclosure, FIG. 25 is a perspective view illustrating the coil discharge unit applied to the hairpin coil forming apparatus according to an embodiment of the present disclosure, and FIG. 26 is a side view illustrating the coil discharge unit applied to the hairpin coil forming apparatus according to an embodiment of the present disclosure.

Referring to FIGS. 24 to 26, the coil discharge unit 90 according to an embodiment of the present disclosure includes a swing block 91, a pair of lower clamp pads 93, and a pair of upper clamp pads 95.

The swing block 91 is disposed to be swingably rotatable on a mounting bracket 92 mounted on the frame 10 (see FIG. 1). The swing block 91 is operably connected to a turning cylinder 97 disposed on the mounting bracket 92.

The swing block 91 can perform swing rotation along the upper-lower direction by operation of the turning cylinder 97. The turning cylinder 97 may, in an example, include a pneumatic cylinder.

Each of the lower clamp pads 93 is operably connected to an up-down clamp cylinder 94 disposed on the swing block 91 and is moved in the upper-lower direction by operation of the up-down clamp cylinder 94. The up-down clamp cylinder 94 may, in an example, include a pneumatic cylinder.

Each of the upper clamp pads 95 is mounted on the swing block 91 and is disposed above the lower clamp pads 93.

When each of the lower clamp pads 93 is moved upward by the operation of the up-down clamp cylinder 94, the lower clamp pads 93 and the upper clamp pads 95 can clamp the leg portions 6b of the hairpin coil 5.

Here, the upper clamp pads 95 can be mounted on moving brackets 96 coupled to the swing block 91 to be movable along the front-rear direction.

Each of the moving brackets 96 is operably connected to a horizontal clamp cylinder 99 disposed on the swing block 91. The moving brackets 96 can be moved toward or away from each other along the front-rear direction through a typical rail by operation of the horizontal clamp cylinder 99. The horizontal clamp cylinder 99 may, in an example, include a pneumatic cylinder.

As described above, as the moving brackets 96 are moved toward or away from each other along the front-rear direction by the operation of the horizontal clamp cylinder 99, the positions of the upper clamp pads 95 can be adjusted to match the set spacing of the leg portions 6b of the hairpin coil 5.

Furthermore, the lower clamp pads 93 are provided in the form of plates with a larger area than the upper clamp pads 95. The upper clamp pads 95 are provided in a block shape.

Below, an operation of the hairpin coil forming apparatus 100 according to an embodiment of the present disclosure configured as described above will be described in detail with reference to FIGS. 1 to 26.

First, the shuttle plate 20 is in a state of being moved to the set position of the frame 10 along the front-rear direction by the operation of the shuttle driving unit 23.

Among the coil forming molds 30 disposed on the shuttle plate 20, one coil forming mold 30 is positioned at the reference point 30a set on the frame 10 by the movement of the shuttle plate 20.

The push block 63 of the mold driving source 60 is in a state of being moved rearward together with at least one upper push rod 65 and at least one lower push rod 67 by the operation of the mold actuator 61.

The upper movable die block 35 of the coil forming mold 30 is in a state of being moved rearward along the left-right direction together with the ball plungers 39 by the elastic restoring force of at least one upper return spring 68. In the instant case, the forming steel portion 34 of the fixed die block 33 of the coil forming mold 30 is in a state of being exposed to the outside due to the rearward movement of the upper movable die block 35.

The lower movable die block 37 of the coil forming mold 30 is in a state of being moved rearward along the left-right direction together with the forming rollers 41 by the elastic restoring force of at least one lower return spring 69.

Here, the forming rollers 41 are moved toward or away from each other by the operation of the position adjustment driving units 51 according to the specifications of the hairpin coil 5 to be finally formed, and maintain the set interval along the front-rear direction.

Furthermore, the forming rollers 41 are moved along the left-right direction by the rotation of the position adjustment bolts 57 according to the specifications of the hairpin coil 5 to be finally formed, and are positioned at the set positions.

The front bracket 75 of the front correction module 71 of the material arrangement correction unit 70 is in a state of being moved rearward toward the front side along the front-rear direction together with the front locating block 77 and the front guide block 79 by the operation of the front actuator 72.

The rear bracket 85 of the rear correction module 81 of the material arrangement correction unit 70 is in a state of being moved rearward along the front-rear direction together with the rear locating block 87 and the rear guide block 89 by the operation of the rear actuator 82.

Here, the front bracket 75 and the rear bracket 85 are in a state of being moved rearward away from each other by a set stroke from the set position by the operation of the front actuator 72 and the rear actuator 82. In the instant case, the front bracket 75 and the rear bracket 85 are in a state of facing each other with a separation section greater than the reference arrangement section 70a of the coil material 1.

The set positions of the front bracket 75 and the rear bracket 85 may be defined as positions where the front bracket 75 and the rear bracket 85 face each other with a separation section corresponding to the reference arrangement section 70a.

Furthermore, the front bracket 75 and the rear bracket 85 are moved along the upper-lower direction by the operation of the front up-down cylinder 76 and the rear up-down cylinder 86 when the shuttle plate 20 moves along the front-rear direction.

Accordingly, when the shuttle plate 20 moves, the front bracket 75 and the rear bracket 85 do not interfere with the coil forming molds 30.

The swing block 91 of the coil discharge unit 90 is in a state of being swing-rotated upward from the reference point 30a of the frame 10 by the operation of the turning cylinder 97.

The lower clamp pads 93 of the coil discharge unit 90 are in a state of being moved downward by the operation of the up-down clamp cylinder 94.

The upper clamp pads 95 of the coil discharge unit 90 are moved toward or away from each other by the operation of the horizontal clamp cylinder 99 according to the specifications of the hairpin coil 5 to be finally formed, and maintain a set interval along the front-rear direction.

As described above, with the coil forming mold 30 positioned at the reference point 30a of the frame 10, the straight coil material 1 having a set length is loaded onto the forming steel portion 34 of the fixed die block 33 by a loader (not shown).

Here, an end portion on one side of the coil material 1 is placed on the front edge locating portion 78a of the front locating block 77 of the front correction module 71 as described above. an end portion on the other side of the coil material 1 is placed on the rear edge locating portion 88c of the rear locating block 87 of the rear correction module 81 as described above.

Next, the front bracket 75 of the front correction module 71 and the rear bracket 85 of the rear correction module 81 are moved forward toward each other (e.g., in the front-rear direction) by the set stroke by the operations of the front actuator 72 and the rear actuator 82.

Accordingly, the front bracket 75 and the rear bracket 85 are positioned at the set positions with a separation section corresponding to the reference arrangement section 70a of the coil material 1.

During the above process, when the straight coil material 1 is misaligned in the left-right direction on the forming steel portion 34 of the fixed die block 33, the front guide block 79 of the front correction module 71 guides an end portion on one side of the coil material 1 to the front stopping step portion 78b of the front locating block 77 through the front guide inclined surface 79a.

In the above case, the rear guide block 89 of the rear correction module 81 guides an end portion on the other side of the coil material 1 to the rear stopping step portion 88d through the rear guide inclined surface 89a.

Then, the position of the straight coil material 1 is corrected to a set posture (or a set position) in which a horizontal state thereof is maintained along the front-rear direction in the reference arrangement section 70a corresponding to the length of the coil material 1.

Here, the rear locating block 87 is mounted to be movable in the front-rear direction on the rear bracket 85 via the guide rods 88a and the rear spring 88b, so deformation of the coil material 1 due to compression can be prevented.

As described above, in a state where the position of the coil material 1 is corrected by the material arrangement correction unit 70, the push block 63 of the mold driving source 60 is moved forward along the left-right direction by the operation of the mold actuator 61.

Accordingly, the push block 63 pushes the upper movable die block 35 and the lower movable die block 37 of the coil forming mold 30 through at least one upper push rod 65 and at least one lower push rod 67.

Then, the upper movable die block 35 and the lower movable die block 37 compress at least one upper return spring 68 and at least one lower return spring 69 and move forward along the left-right direction.

Here, the upper movable die block 35 first moves forward by the set stroke through at least one upper push rod 65, and then the lower movable die block 37 moves forward by the set stroke through at least one lower push rod 67.

As the upper movable die block 35 moves forward as described above, the balls 45 of the ball plungers 39 come into rolling contact with the straight coil material 1, and bend and form the straight coil material 1 into a V-shape along the forming steel portion 34.

In addition, as the lower movable die block 37 moves forward as described above, the forming rollers 41 come into rolling contact with the pre-formed coil 3 that has been bent and formed into a V-shape by the ball plungers 39. Accordingly, the forming rollers 41 bend and form the pre-formed coil 3 into a U-shape along the forming steel portion 34.

Therefore, the coil forming mold 30 according to an embodiment of the present disclosure can continuously perform the primary V-shape forming process and the secondary U-shape forming process of the straight coil material 1 described above, and form the final hairpin coil 5.

When the forming of the hairpin coil 5 is completed in this manner, the lower clamp pads 93 of the coil discharge unit 90 are moved upward toward the upper clamp pads 95 by the operation of the up-down clamp cylinder 94.

Then, the lower clamp pads 93 and the upper clamp pads 95 clamp the leg portions 6b of the hairpin coil 5.

Next, the push block 63 of the mold driving source 60 is moved rearward along the left-right direction by the operation of the mold actuator 61.

Accordingly, the upper movable die block 35 and the lower movable die block 37 are moved rearward along the left-right direction by the elastic restoring forces of at least one upper return spring 68 and at least one lower return spring 69 and are thus returned to the original positions.

Then, when the swing block 91 of the coil discharge unit 90 is configured to perform swing rotation downward by the operation of the turning cylinder 97, the hairpin coil 5 can be discharged while being clamped to the lower clamp pads 93 and the upper clamp pads 95.

The hairpin coil forming apparatus 100 according to an embodiment of the present disclosure as described so far can position the straight coil material 1 at the set position in the set posture by means of the material arrangement correction unit 70, and form the coil material 1 into the U-shaped hairpin coil 5 by means of the coil forming molds 30.

Therefore, the hairpin coil forming apparatus 100 according to an embodiment of the present disclosure can minimize the quality variation of the hairpin coil 5 that is finally formed, for example, the length deviation of the leg portions 6b.

Accordingly, according to the hairpin coil forming apparatus 100 according to an embodiment of the present disclosure, the forming quality of the hairpin coil 5 can be improved, the repetitive forming precision of the hairpin coil 5 can be improved, and the productivity of the hairpin coil 5 can be improved.

Although the embodiments of the present disclosure have been described above, the technical idea of the present disclosure is not limited to the embodiments presented in the present specification, and one skilled in the art who understands the technical idea of the present disclosure will be able to easily propose other embodiments by adding, changing, deleting, or adding components within the scope of the same technical idea, which are also be considered to fall within the scope of the present disclosure.

<Description of symbols>

| | |
|---|---|
| 1: coil material | 3: pre-formed coil |
| 5: hairpin coil | 6a: head portion |
| 6b: leg portion | 10: frame |
| 20: shuttle plate | 21: shuttle rail |
| 23: shuttle driving unit | 25: shuttle connection block |
| 27: first servo motor | 29: first guide mechanism |
| 30: coil forming mold | 30a: reference point |
| 30b: front section | 30c: rear section |
| 31: mold holder | 32a: base block |
| 32b: upper block | 32c: support block |
| 33: fixed die block | 34: forming steel portion |
| 35: upper movable die block | 37: lower movable die block |
| 38: guide rail | 39: ball plunger |
| 41: forming roller | 43: plunger body |
| 44: screw thread | 45: ball |
| 47: moving block | 49: rail block |
| 51: position adjustment driving | 53: second servo motor |
| unit | |
| 55: mount block | 57: positioning bolt |
| 59: roller shaft | 60: mold driving source |
| 61: mold actuator | 62: third servo motor |
| 62a: lead screw | 63: push block |
| 64: rail member | 65: upper push rod |
| 67: lower push rod | 68: upper return spring |
| 69: lower return spring | 70: material arrangement |
| | correction unit |
| 71: front correction module | 72: front actuator |
| 73: fourth servo motor | 74: front moving member |
| 74a: second guide mechanism | 75: front bracket |
| 76: front up-down cylinder | 77: front locating block |
| 78a: front edge locating portion | 78b: front stopping step portion |
| 79: front guide block | 79a: front guide inclined surface |
| 81: rear correction module | 82: rear actuator |
| 83: fifth servo motor | 84: rear moving member |
| 84a: third guide mechanism | 85: rear bracket |
| 86: rear up-down cylinder | 87: rear locating block |
| 88a: guide rod | 88b: rear spring |
| 88c: rear edge locating portion | 88d: rear stopping step portion |
| 89: rear guide block | 89a: rear guide inclined surface |
| 90: coil discharge unit | 91: swing block |
| 92: mounting bracket | 93: lower clamp pad |
| 94: up-down clamp cylinder | 95: upper clamp pad |
| 96: moving bracket | 97: turning cylinder |
| 99: horizontal clamp cylinder | 100: hairpin coil forming apparatus |

What is claimed is:

1. A hairpin coil forming apparatus configured to form a straight coil material having a set length into a predetermined shape, the apparatus comprising:
a frame;
a shuttle plate disposed on the frame to be movable along a first direction;
at least two or more coil forming molds disposed on the shuttle plate;
a mold driving source disposed on the frame to apply a drive force to one coil forming mold, which is positioned at a reference point of the frame, of the at least two coil forming molds; and
a material arrangement correction unit disposed on the frame to position the coil material loaded on the one coil forming mold at a set position in a set reference arrangement section.

2. The hairpin coil forming apparatus of claim 1, further comprising:
a coil discharge unit disposed at a reference point of the frame to discharge a hairpin coil formed by the one coil forming mold.

3. The hairpin coil forming apparatus of claim 1, wherein the shuttle plate is slidably coupled to at least one shuttle rail disposed on an upper surface of the frame along the first direction and is connected to a shuttle driving unit disposed on the frame.

4. The hairpin coil forming apparatus of claim 1, wherein each of the at least two coil forming molds comprises:
a mold holder fixed to the shuttle plate,
a fixed die block fixed to the mold holder and having a U-shaped forming steel portion formed therein,
an upper movable die block disposed on the mold holder to be movable in a second direction at a position corresponding to the fixed die block, and
a lower movable die block disposed on the mold holder below the upper movable die block to be movable in the second direction.

5. The hairpin coil forming apparatus of claim 4, wherein each of the at least two coil forming molds further comprises:
a pair of ball plungers disposed to the upper movable die block to form the straight coil material loaded onto the forming steel portion into a V-shape, and
a pair of forming rollers disposed to the lower movable die block to form the pre-formed coil, which has been formed into a V-shape by the pair of ball plungers, into a U-shape.

6. The hairpin coil forming apparatus of claim 5, wherein each of the at least two coil forming molds further comprises:
at least one upper return spring disposed to the mold holder at a position corresponding to the upper movable die block, and
at least one lower return spring disposed to the mold holder at a position corresponding to the lower movable die block.

7. The hairpin coil forming apparatus of claim 5, wherein the pair of forming rollers are mounted to moving blocks coupled to the lower movable die block to be movable toward or away from each other along the first direction, respectively.

8. The hairpin coil forming apparatus of claim 7,
wherein the moving blocks are connected to position adjustment driving units disposed on the mold holder,
wherein the forming rollers are mounted to mounting blocks coupled to the moving blocks to be movable along the second direction, and
wherein the mounting blocks are fastened to position adjustment bolts rotatably coupled to the moving blocks.

9. The hairpin coil forming apparatus of claim 4, wherein the mold driving source comprises:
a mold actuator disposed on the frame;
a push block connected to the mold actuator and disposed on the frame to be movable in the second direction by operation of the mold actuator;
at least one upper push rod mounted to an upper portion of the push block to push the upper movable die block; and
at least one lower push rod mounted to a lower portion of the push block to push the lower movable die block.

10. The hairpin coil forming apparatus of claim 1, wherein the material arrangement correction unit comprises:
a front correction module and a rear correction module disposed at front and rear portions of the frame, respectively, with the mold driving source interposed therebetween.

11. The hairpin coil forming apparatus of claim 10, wherein the front correction module comprises:
a front actuator disposed at a front portion of the frame,
a front moving member connected to the front actuator and configured to move in the first direction by operation of the front actuator,
a front bracket disposed on the front moving member and disposed along a second direction,
a front locating block fixed to the front bracket, and
a front guide block mounted to the front locating block.

12. The hairpin coil forming apparatus of claim 11, wherein the front bracket is connected to a front up-down cylinder disposed on the front moving member and is configured to move in a third direction by operation of the front up-down cylinder.

13. The hairpin coil forming apparatus of claim 11, wherein the rear correction module comprises:
a rear actuator disposed at a rear portion of the frame;
a rear moving member connected to the rear actuator and configured to move in the first direction by operation of the rear actuator;
a rear bracket disposed on the rear moving member and disposed along the second direction;
a rear locating block mounted to the rear bracket to be movable in the first direction; and
a rear guide block mounted to the rear locating block.

14. The hairpin coil forming apparatus of claim 13, wherein the rear bracket is connected to a rear up-down cylinder disposed on the rear moving member and is configured to move in a third direction by operation of the rear up-down cylinder.

15. The hairpin coil forming apparatus of claim 13,
wherein the front locating block comprises a front edge locating portion configured to support an end portion on a first side of the coil material, and a front stopping step portion stepped upward from the front edge locating portion, and
wherein the rear locating block comprises a rear edge locating portion configured to support an end portion on a second side of the coil material, and a rear stopping step portion stepped upward from the rear edge locating portion.

16. The hairpin coil forming apparatus of claim 15,
wherein the front guide block includes a front guide inclined surface formed to guide the end portion on the first side of the coil material to the front stopping step portion, and
wherein the rear guide block includes a rear guide inclined surface formed to guide the end portion on the second side of the coil material to the rear stopping step portion.

17. The hairpin coil forming apparatus of claim 13,
wherein the rear locating block is mounted to the rear bracket to be movable in the first direction through at least one guide rod fixed to the rear bracket, and
wherein a rear spring is mounted to the at least one guide rod.

18. The hairpin coil forming apparatus of claim 2, wherein the coil discharge unit comprises:
a swing block connected to a turning cylinder disposed on the frame and configured to perform swing rotation in a third direction by operation of the turning cylinder;
a pair of lower clamp pads connected to an up-down clamp cylinder disposed on the swing block and configured to move in the third direction, respectively, by operation of the up-down clamp cylinder; and
a pair of upper clamp pads mounted to the swing block and disposed above the pair of lower clamp pads.

19. The hairpin coil forming apparatus of claim 18, wherein the pair of upper clamp pads are connected to a horizontal clamp cylinder disposed on the swing block and are configured to move toward or away from each other along the first direction by operation of the horizontal clamp cylinder.
